(19) United States
(12) Patent Application Publication
(10) Pub. No.: US 2005/0008550 A1
(43) Pub. Date: Jan. 13, 2005

(54) Low-power atmospheric pressure mini-plasma and array for surface and material treatment

(76) Inventor: Yixiang Duan, White Rock, NM (US)

Correspondence Address: UNIVERSITY OF CALIFORNIA;LOS ALAMOS NATIONAL LABORATORY, P.O. BOX 1663, MS A187, LOS ALAMOS, NM, 87545, US

(21) Appl. No.: 10/616,610

(22) Filed: Jul. 9, 2003

(51) Int. Cl. B01J 19/08; B01J 19/12

(52) U.S. Cl. 422/186.04

(57) ABSTRACT

An apparatus for creating an atmospheric mini-plasma. The apparatus uses both a plasma support gas and a plasma reactive gas attached to a conduit in communication with a plasma generating region. The plasma generating region is designed with a gas inlet leading to a tube containing two parallel electrodes. The electrodes are attached to a direct current, continuous or pulsed, power supply that provides the electrical potential to create the atmospheric mini-plasma. The atmospheric mini-plasma discharges from the generating region opposite to the gas inlet. As the design of the plasma generating region is relatively small, a plurality of generating regions may be coupled together in an array. The additional feature of a pulsed power supply allows a compact design that is portable for field use.

### STATEMENT REGARDING FEDERAL RIGHTS

This invention was made with government support under Contract No. W-7405-ENG-36 awarded by the U.S. Department of Energy. The government has certain rights in the invention.

### FIELD OF THE INVENTION

The present invention relates generally to low-power atmospheric pressure plasmas and more specifically to low-power mini-plasma arrays used for the purpose of surface and material treatment.

### BACKGROUND OF THE INVENTION

Surface treatment and cleaning is a fundamental requirement for many industrial processes, especially in the semi-conductor industry. Surface treatment finishing steps, such as printing, coating, lacquering, and gluing are only possible on films, plastics, or metals, if an adequate surface wettability with the solvent or water-based printing inks, lacquers, primers, or adhesives exists. Surface cleaning, such as decontamination, is also a problem area.

As described in U.S. Pat. No. 5,961,772, issued Oct. 5, 1999, decontamination of surfaces has traditionally been accomplished using solvent-based methods. However, increasing concerns about ground water and air pollution, greenhouse gases, and related health and safety issues have severely restricted the use of common volatile organic solvents used in decontamination, and even many of the recently adapted, less hazardous substitutes. The low-power atmospheric plasma produced in accordance with the present invention addresses these problems.

Plasma cleaning is often used as a means for surface cleaning and is especially effective against hydrocarbon and other organic surface contaminants. Studies of plasmas used for surface cleaning have shown that atomic and metastable oxygen are especially reactive to organic contaminants. Plasmas have been used extensively in a wide variety of industrial and high technology applications, from semiconductor fabrication to coatings of reflective films for window panels and compact disks. Plasmas ranging in pressure from high vacuum (<0.1 mTorr) to several Torr are most common, and have been used for film deposition, surface coating, reactive ion etching, sputtering and other forms of surface modification. The primary advantage of plasma cleaning is that it is an “all-dry” process, generates minimal effluent, does not require hazardous components, and is applicable to a wide variety of vacuum-compatible materials, including silicon, metals, glass, and ceramics.

However, these low-pressure plasmas traditionally require use of a significant vacuum device which restricts applications for material surface treatment. The ability to use a plasma at ambient atmospheric pressure as embodied in the present invention does not require the article to be evacuated. The ability to operate at atmospheric pressure significantly reduces processing costs and removes the additional requirement that the subject article needs to be cleaned or treated to survive under reduced pressure.

Current forms of atmospheric pressure plasmas include plasma torches and flames, which rely on high-power dc or rf discharges and thermal ionization, respectively; operate at high temperatures; and produce substantial ionization. These high power plasmas destroy most surfaces to which they are applied, since the plasmas operate at extremely high temperatures and produce significant concentrations of ions. The low power aspect of the present invention mitigates these issues.

Another type of frequently used atmospheric plasma is a corona discharge. In spite of its broad use and constant development, corona discharge for material or surface treatment includes significant disadvantages. For example, in the treatment of a film, corona discharge causes a significant electrostatic charging of the material, which interferes with subsequent processing steps and actually places a charge on the film. As corona treatment is a filament discharge, it does not generate a homogeneous surface effect and, thus, is improper for many applications. Further, corona treatment is currently limited to thin substrates, such as films of plastic and papers. In the case of thicker materials the overall resistance between the electrodes is too high to ignite the discharge. Finally, corona discharge is not a method of choice for use on electrically conductive plastics. None of these detrimental effects or limitations exist with use of the present invention.

Surface treatments can also be carried out by flame treatment. Flame treatment is conventionally carried out at temperatures around 1,700° C. and at distances of 5 to 150 mm. Since the films heat up to high temperatures, effective cooling must be undertaken. A significant disadvantage of flame treatment is the requirement that process parameters must be strictly controlled, especially in the surface treatment of films: too low a treatment intensity leads to minor defects, too high an intensity leads to melting of the film surface. The high temperatures and the necessary safety precautions are disadvantages. Further, only a restrictive number of reactive species are available for flame treatment, and the costs of flame treatment are significantly higher than corona treatment.

In U.S. Pat. No. 5,414,324, issued May 9, 1995, a one-atmosphere, steady-state glow discharge plasma with a potential of 1-5 kV is described. The glow discharge plasma disclosed is produced by free electrons which are energized by imposed dc or rf electric fields and then collide with neutral molecules to generate a plasma. Surrounding the discharge assembly is an environmental isolation enclosure in which a low feed gas flow is maintained in order to equal the leakage rate of the enclosure. Materials may be processed by passing them through the plasma between the electrodes, where they are exposed to all plasma constituents including ions. Also see U.S. Pat. No. 5,456,972, “Method And Apparatus For Glow Discharge Plasma Treatment Of Polymer Materials At Atmospheric Pressure” issued Oct. 10, 1995.

In U.S. Pat. No. 5,961,772, issued Oct. 5, 1999, an atmospheric pressure plasma jet using rf power was developed through a resonant-cavity and operated with 300 to 500 watts. The plasma was generated in the annular region between cylindrical electrodes, and supplied with rf energy to either of the central electrode or the electrically conducting chamber for sustaining the plasma. An active chemical stream using about 1% oxygen was channeled into the inert gas stream for cleaning and etching purposes. In addition, unlike the present invention, helium must be used as part of working gas in order to prevent arcing within the discharge. A cooling device is also required.

Accordingly, it is an object of the present invention to generate low-power, robust, and portable plasma devices, individually or in an array, capable of producing significant active chemical species for surface cleaning, coating, modification, and film processing.

Additional objects, advantages and novel features of the invention will be set forth in part in the description which follows, and in part will become apparent to those skilled in the art upon examination of the following or may be learned by practice of the invention. The objects and advantages of the invention may be realized and attained by means of the instrumentalities and combinations particularly pointed out in the appended claims.

### SUMMARY OF THE INVENTION

In accordance with the purposes of the present invention, as embodied and broadly described herein, the present invention is an apparatus for creating an atmospheric mini-plasma. The apparatus uses both a plasma support gas and a plasma reactive gas attached to a conduit in communication with a plasma generating region. The plasma generating region is designed with a gas inlet leading to a chamber containing two parallel electrodes. The electrodes are attached to a direct current, continuous or pulsed, power source that provides the ionizing potential to create the atmospheric mini-plasma. The atmospheric mini-plasma is generated in the discharge opening opposite the gas inlet. As the plasma discharge opening is relatively small, a plurality of generating regions may be coupled together in an array in order to increase the number of possible uses of the apparatus.

### BRIEF DESCRIPTION OF THE DRAWINGS

The accompanying drawings, which are incorporated in and form a part of the specification, illustrate embodiments of the present invention and, together with the description, serve to explain the principles of the invention. In the drawings:

FIG. 1 is a pictorial illustration of an apparatus based on a mini-plasma source for material surface treatment using a pulsed power mode.

FIG. 2 is a pictorial illustration of an apparatus based on a mini-plasma source for material surface treatment using a continuous power mode.

FIG. 3 is a cross-sectional view of the plasma discharge design with separated gas introduction into the plasma discharge device.

FIGS. 4A, 4B, 4C, and 4D are a pictorial illustrations of mini-plasma array devices with plasma and reaction gases introduced through the same main-flow channel.

### DETAILED DESCRIPTION

Plasmas consists of a collection of free-moving electrons and ions—atoms that have lost electrons. Energy is needed to strip electrons from atoms to make plasma. The energy can be of various origins: thermal, electrical, or light. In the present invention electrical energy is used. The transition from a gas to an ionized gas occurs with increasing energy deposition into the target gas or gases. During the process, inert gases are ionized as a result of freeing the outermost orbital electrons. The resulting plasma consists of a mixture of neutral particles, positive ions, and negative electrons. With insufficient sustaining power, plasmas recombine into a neutral gas.

The present invention comprises an apparatus that produces an atmospheric plasma, which is a plasma created at ambient pressure. The atmospheric plasma can be used for surface treatment and cleaning, to include: printing, coating, lacquering, gluing and surface decontamination. The atmospheric mini-plasma generated by the present invention is easily maintained with various gases or mixtures of gases, such as: helium, argon, nitrogen, and air. Gas flow rates may be varied from a few milliliters per minute to several liters per minute, depending on the discharge chamber design and the desired size of the plasma discharge and sought after characteristics.

The plasma support gases, used in the present invention, exhibit high excitation potentials and consequently generate highly energized metastable species or active species of the plasma reactive gas through three-body collision or direct collision of energized electrons with neutral molecules. These active reaction chemical species can then be used for surface treatment, cleaning, coating or decontamination. For example, the metastable oxygen O₂* is formed in a plasma with a lifetime ranging from about 0.1 sec at atmospheric pressure, to many seconds at reduced pressures, and has about 1 eV of internal energy to promote its chemical reactivity. Metastable oxygen production in plasmas is increased at higher pressures due to the three-body collisions, such as 2O atoms and an O₂ molecule. Metastable oxygen is also produced by direct collision of an O₂ molecule with an electron, where the electron temperature has been optimized around 1 eV. Use of metastable oxygen for cleaning surfaces permits plasma processing of both vacuum compatible and incompatible materials at reduced cost and complexity.

The power supply for the present invention is operated in a direct current (DC), provided in either a continuous mode, or a pulsed power mode in order to reduce the power consumption of the plasma discharge. The input voltage range provided by the primary DC source is from about 1 to 24 volts, with a preferred range of 3 to 12 volts. In a continuous mode, a DC source is connected to a conventional DC-DC converter, such as those sold by Ultra Volt, Inc., to step up the output voltage to the necessary operable range. In the pulsed power mode, a low power DC source is connected to a pulse generator and a transformer that provides the operable output voltage.

The low primary DC power requirement in the pulsed mode creates an opportunity to use dry-cell batteries to power the plasma. As a result, the low power characteristic makes the present invention very flexible for field use through the corresponding reduction in size of the apparatus. For example, a duty cycle of 10:1 in a pulsed power mode means that the power consumptions is about ten times less than experienced in a continuous DC mode.

The power supply output voltage requirement for the present invention is about 100 to 10,000 volts, and the preferred range is from about 400 to 3000 volts. The voltage is applied via planar electrodes sized in range from approximately 0.1 mm² to 500 mm², with a preferred range of about 0.1 mm² to 10 mm². The corresponding plasma chamber sizes range from about 0.2 microliter to 2 milliliters.

To achieve the high voltage for the plasma discharge in the pulsed mode, a low input voltage is applied to the secondary wires of a power transformer, allowing a high output voltage in the primary wires during discharge cycles. Either a low voltage DC power supply or a dry-cell battery may be used as the primary energy source to generate the required high voltage for the plasma discharge. The duty cycle of the pulse is modulated with a pulse generator, which is used for controlling time delay or oscillation. A power transistor within the pulse generator activates a switch in the DC power circuit to switch the pulse on and off creating the necessary change in current through the power transformer. Testing of the present invention has demonstrated that power consumption can be as low as the milli-watts range when operated in a pulsed power mode. Both the discharge chamber and the electrodes last a relatively long time in regular operation, on the order of several months.

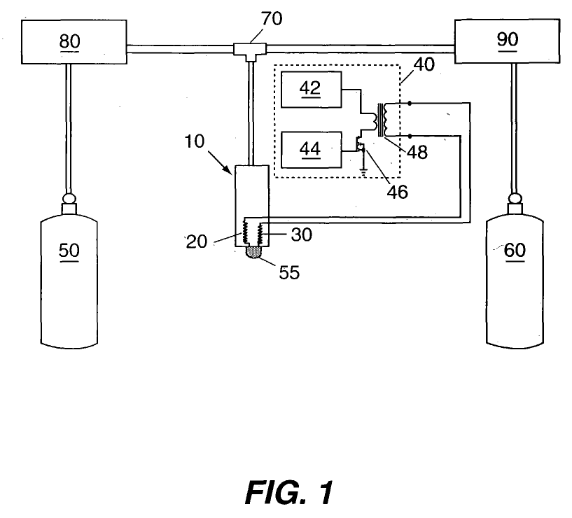

Referring to an exemplary embodiment of the present invention shown in FIG. 1, plasma chamber 10, is fabricated from a non-conducting material, such as Teflon or ceramic, with either round or square cross-section, which forms a plasma discharge chamber. Two planar metal electrodes 20 and 30 are placed in parallel with one another within plasma chamber 10. A DC pulsed voltage is applied to electrodes 20 and 30 through power supply 40. Power supply 40 comprises DC source 42 connected to pulse-generator 44, switch 46, and power transformer 48; this configuration creates an opportunity to use dry-cell batteries as a primary power source.

Plasma support gas 50 and active gas 60 are metered to T-connector 70 by flowmeters 80 and 90, respectively, where they are mixed and directed into plasma chamber 10. Plasma jet 55 is formed by the presence of plasma support gas 50 and active reaction gas 60 in the presence of the applied voltage field imposed across electrodes 20 and 30 and emerges from chamber 10. The flame length of resulting plasma jet 55 may be modified through adjustment of gas flow controllers 80 and 90 and/or adjustment of power supply 40.

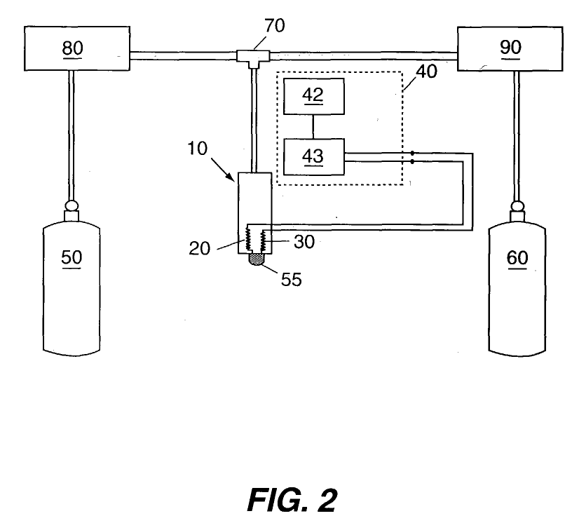

In another exemplary embodiment of the present invention, FIG. 2 displays the use of a continuous power source. Power supply 40 in this configuration uses DC-DC converter 43 to raise the voltage of DC source 42 to output high voltage range required to sustain plasma jet 55.

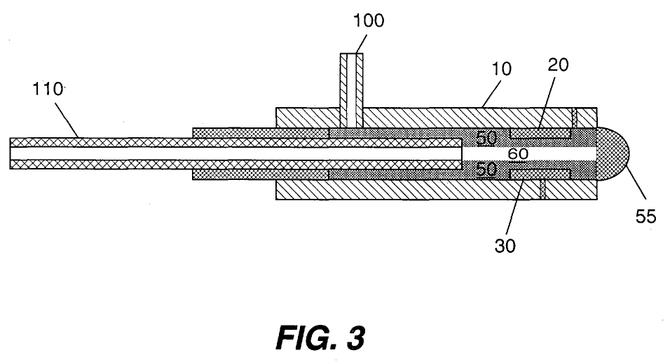

Two exemplary designs may be employed to mix the active reaction gas with the plasma inert gas. The first design is to pre-mix the plasma support gas and active gas prior to entering the plasma chamber through either a T-type (as in FIG. 1) or a Y-type connector. The second design is achieved through a particular discharge chamber design shown in FIG. 3. Here, gas channel 100 directs plasma support gas 50, in a separated gas introduction, into plasma chamber 10 providing a surrounding layer of support gas between active reaction gas 60 and the walls of plasma chamber 10. Thus, active reaction gas 60 is surrounded by plasma support gas 50 as it passes through the discharge chamber and consequently maintains a stronger plasma source and higher plasma tolerance. This improves the performance and capabilities of atmospheric pressure plasma jet 55. Further, plasma jet 55 exhibits an increased tolerance to foreign materials and gases than a pre-mixed gas flow.

The low-power consumption and low-gas flow rates allow for a portable, or even a handheld, plasma device for surface treatment. In addition, when the apparatus plasma volume is operated in the microliter scale (0.2 μL-100 μL), some very special features and characteristics are exhibited: low thermal temperature (tail plume close to room temperature) while maintaining high electron temperature, moderate plasma density, no need for a cooling device, and no need for a vacuum device.

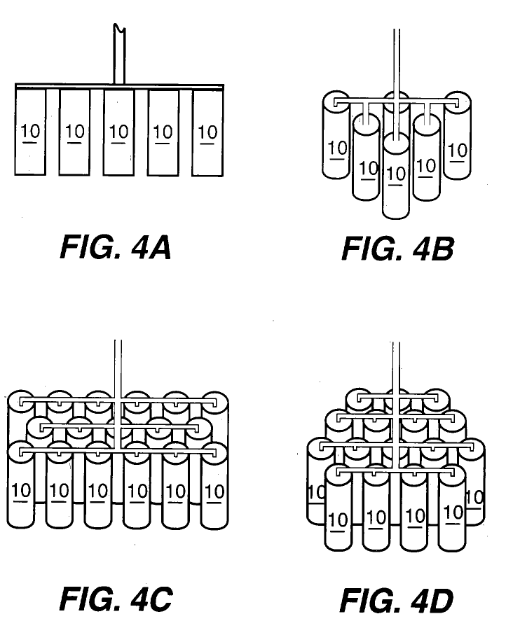

In one embodiment, the present invention operated in the micro-liter scale, of a plurality of plasma chambers 10 may be grouped as an array that can be used for large area surface treatment and/or cleaning. It is a benefit of the present invention that technical problems may be addressed through the flexibility of grouping the plasma chambers in configurations that solve geometric limitations imposed by varying surface conditions. Four exemplary configurations are shown in FIG. 4: FIG. 4A is a pictorial illustration of a straight line array; FIG. 4B is a pictorial illustration of a triangular array; FIG. 4C is a pictorial illustration of a box array; and FIG. 4D is a pictorial illustration of a circular array. Thus, based on the small size of plasma chamber 10, arrays may be configured in almost unlimited patterns to meet the needs of the user.

The foregoing description of the invention has been presented for purposes of illustration and description and is not intended to be exhaustive or to limit the invention to the precise form disclosed, and obviously many modifications and variations are possible in light of the above teaching.

The embodiments were chosen and described in order to best explain the principles of the invention and its practical application to thereby enable others skilled in the art to best utilize the invention in various embodiments and with various modifications as are suited to the particular use contemplated. It is intended that the scope of the invention be defined by the claims appended hereto.

1. An apparatus for creating an atmospheric mini-plasma comprising,
a. a supply of a support gas;
b. a supply of a reactive gas;
c. a plasma generating region in communication with said gas supplies;
d. said plasma generating region comprising a first gas inlet, a plasma chamber having an inner wall coupled to said gas inlet, and a plasma discharge opening coupled to said chamber;
e. a first planar electrode within said plasma chamber;
f. a second planar electrode within said plasma chamber, in parallel with said first planar electrode, said first and second planar electrodes used for applying a high voltage field for ionizing said support gas and said reactive gas at atmospheric pressure; and
g. a high voltage direct current power supply connected to said first and second planar electrodes.

2. The apparatus of claim 1 where said gas supplies are attached to a connector where said support gas and said reactive gas are mixed prior to entering into said plasma generating region.

3. The apparatus of claim 2 where said connector is selected from a group consisting of a T-connector or a Y-connector.

4. The apparatus of claim 1 where said reactive gas enters said plasma generating region through said first gas inlet and said support gas enters said plasma generating region through a second gas inlet providing a layer of support gas between said inner wall and said reactive gas.

5. The apparatus of claim 1 where said support gas is metered from said support gas supply by a first flowmeter, and said reactive gas is metered from said reactive gas supply by a second flowmeter.

6. The apparatus of claim 1 where said high voltage power supply comprises a direct current power source and a DC-DC converter.

7. The apparatus of claim 1 where said high voltage power supply comprises a direct current power source, a pulse generator connected to a switch, and a power transformer.

8. The apparatus of claim 6 where said direct current power source is a dry-cell battery.

9. The apparatus of claim 8 where said dry-cell battery is an alkaline battery.

10. The apparatus of claim 7 where said direct current power source is a dry-cell battery.

11. The apparatus of claim 10 where said dry-cell battery is an alkaline battery.

12. The apparatus of claim 1 where said support gas supply is selected from a group consisting of all inert gases.

13. The apparatus of claim 1 where said support gas supply is selected from the group consisting of helium, argon, nitrogen, oxygen, and air.

14. The apparatus of claim 1 where said reactive gas supply is selected from the group consisting of oxygen, nitrogen, chlorine, and fluorine.

15. The apparatus of claim 1 wherein said reactive gas supply is selected from the group consisting of gaseous compounds of oxygen, nitrogen, chlorine, and fluorine.

16. The apparatus of claim 1 where a plurality of said plasma generating regions in an array are in communication with said gas supplies.
